(19) United States
(12) Patent Application Publication
(10) Pub. No.: US 2026/0089607 A1
(43) Pub. Date: Mar. 26, 2026

(54) CONTROLLING AVAILABILITY OF ACCESS NETWORKS BASED ON AWARENESS OF USER LOCATION

(71) Applicant: AT&T Intellectual Property I, L.P., Atlanta, GA (US)

(72) Inventors: Sridhar Narahari, Milpitas, CA (US); John Gibbons, Ballston Lake, NY (US); Barry Elia, King George, VA (US); Michael Satterlee, Clifton Park, NY (US)

(73) Assignee: AT&T Intellectual Property I, L.P., Atlanta, GA (US)

(21) Appl. No.: 18/893,170

(22) Filed: Sep. 23, 2024

(51) Int. Cl. H04W 48/04; H04W 12/08; H04W 12/63; H04W 48/08

(52) U.S. Cl. CPC H04W 48/04; H04W 12/08; H04W 12/63; H04W 48/08

(57) ABSTRACT

Aspects of the subject disclosure may include, for example, determining a first physical location serviceable by a private access network and an indication of physical location of a user. The first physical location can be compared to the second physical location to obtain a first comparison result. Activation of the wireless access network can be controlled according to the comparison result between an active state in which the wireless access network is available for network service at the first physical location and an inactive state in which the wireless access network is unavailable for service at the first physical location. Other embodiments are disclosed.

### FIELD OF THE DISCLOSURE

The subject disclosure relates to controlling availability of access networks based on awareness of user location.

### BACKGROUND

Many entities (e.g., organizations, businesses, universities, and other entities including residences) implement private networks for their industry-specific and/or personal data and/or communication needs. For example, a private network may be deployed to host applications, store files, etc., for access by users (e.g., employees and/or clients of a business, students and/or teachers at a university, etc.) and/or provide access to other networks, such as the Internet.

Wireless access points (WAPs) allow computing devices to establish a wireless communications connection through the WAP and to the Internet. A WAP may advertise its availability for connections by broadcasting a service set identifier (SSID) that may be detected via a computing device. Some WAPs broadcast multiple SSIDs, such as one for the owner of the WAP, which requires one password or set of credentials for authorization, and another for guests, which requires a different password or set of credentials for authorization (or even no credentials at all).

In computer networking, a WAP is a networking hardware device that allows a Wi-Fi compatible client device to connect to a wired network and to other client devices. The WAP usually connects to a router (directly or indirectly via a wired network) as a standalone device, but it can also be an integral component of the router itself. Wireless networks can provide access for workers to work in remote locations.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a networking system in accordance with various aspects described herein.

FIG. 2A is a block diagram illustrating an example, non-limiting embodiment of a controllable network enablement system functioning within the networking system of FIG. 1 in accordance with various aspects described herein.

FIG. 2B is a block diagram illustrating an example, non-limiting embodiment of another controllable network enablement system functioning within the networking system of FIG. 1 in accordance with various aspects described herein.

FIG. 2C is a block diagram illustrating an example, non-limiting embodiment of another controllable network enablement system functioning within the networking system of FIG. 1 in accordance with various aspects described herein.

FIG. 2D is a block diagram illustrating an example, non-limiting embodiment of another controllable network enablement system functioning within the networking system of FIG. 1 in accordance with various aspects described herein.

FIG. 2E is a block diagram illustrating an example, non-limiting embodiment of another controllable network enablement system functioning within the networking system of FIG. 1 in accordance with various aspects described herein.

FIG. 2F depicts an illustrative embodiment of a process for controlling enablement of a private access network in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for controlling an availability of an access network based on a location of an individual. Other embodiments are described in the subject disclosure.

One or more aspects of the subject disclosure include a process that includes determining, by a processing system including a processor, a first physical location serviceable by a wireless access network. The process also includes determining, by the processing system, an indication of a second physical location of a member of a first user group and comparing, by the processing system, the first physical location to the second physical location to obtain a first comparison result. According to the process, activation of the wireless access network can be controlled, by the processing system and according to the first comparison result, between an active state in which the wireless access network is available for network service at the first physical location and an inactive state in which the wireless access network is unavailable for service at the first physical location.

One or more aspects of the subject disclosure include a system having a processing system including a processor and a memory that stores executable instructions. The executable instructions, when executed by the processing system, facilitate performance of operations that include identifying a first location serviceable by a private access network. The operations also include identifying a second location of a user and comparing the first location to the second location to obtain a comparison result. The operations further include and controlling activation of the private access network according to the comparison result between an active state in which the private access network is available for network service at the first location and an inactive state in which the private access network is unavailable for service at the first location.

One or more aspects of the subject disclosure include a non-transitory, machine-readable medium, that includes executable instructions that, when executed by a processing system including a processor, facilitate performance of operations. The operations include determining a first location serviceable by a private access network. The operations alco include determining an indication of a second location of a user and comparing the first location to the second location to obtain a comparison result. The operations further include controlling activation of the private access network, according to the comparison result, between an active state in which the private access network is available for network service at the first location and an inactive state in which the private access network is unavailable for service at the first location.

There are many problems with the security of current WAPs, some of which are well known. In particular, private networks that are accessible via a hosting WAP, e.g., advertised, remain vulnerable to attempts of unauthorized access to gain access, i.e., by hacking, as long as they remain accessible and/or otherwise enabled or publicly exposed. Consider a private residential or home network that is advertised via normal operating procedures of a home Wi-Fi router. Although the network may be secured using standard techniques, e.g., password protection, a threat remains that unauthorized users may attempt to gain access as long as the network remains accessible. It is recognized that there may be periods during which authorized users are not utilizing the private network, yet the network remains exposed and vulnerable to hackers.

The techniques disclosed herein address this vulnerability by controlling the availability and/or accessibility of private networks according to location information. For example, a private network may be activated and/or otherwise enabled responsive to a determination that an authorized user is located within some predetermined proximity of the home router, or more generally the hosting WAP. Beneficially, the example private network may be deactivated and/or otherwise disabled responsive to a determination that the authorized user is no longer located within some predetermined proximity of the hosting WAP. Thus, when members of the home are away at work and/or school, the home network can be disabled to remove any vulnerability to unauthorized access. When a member of the home returns, the private network may be reactivated to operate as usual.

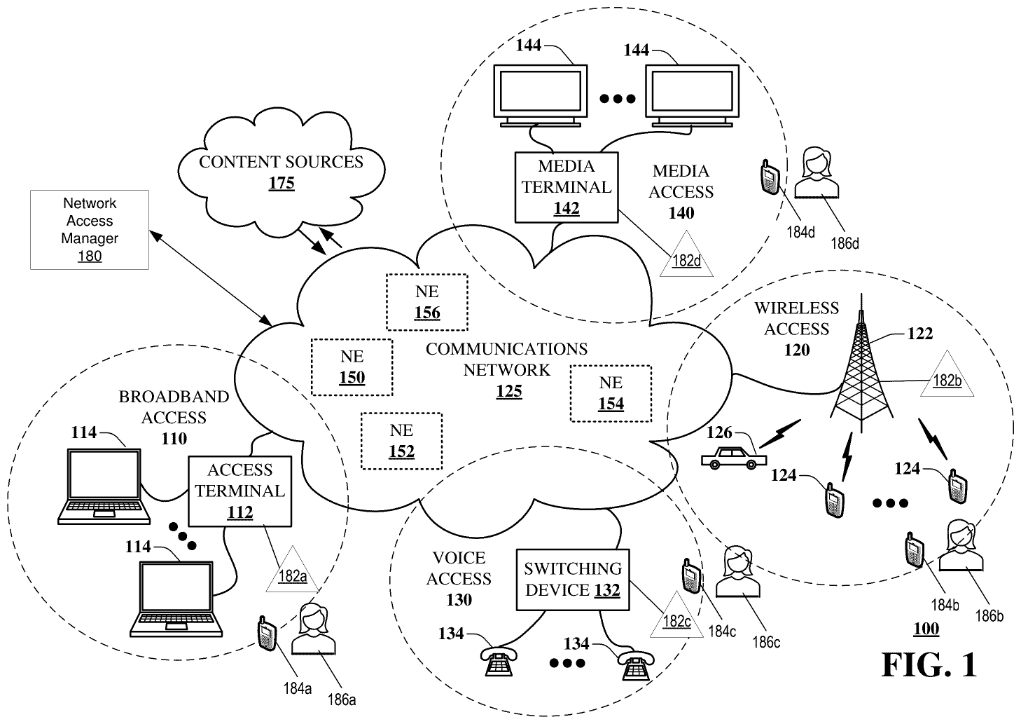

Referring now to FIG. 1, a block diagram is shown illustrating an example, non-limiting embodiment of a networking system 100 in accordance with various aspects described herein. For example, the networking system 100 can facilitate in whole or in part control over an availability of a private access network. For example, a private access network, such as a wireless area network (WAN), e.g., a Wi-Fi network, may be configured to be available, or otherwise activated, based on a satisfaction of one or more rules related to a location of an authorized user. To the extent the rule(s) are not satisfied, the private access network can be controlled to an unavailable, or otherwise deactivated condition. For example, if the authorized user is at a location proximate to a coverage region of the WAN, a hosting wireless router can advertise the private access network, e.g., allowing the authorized user and/or any other authorized user to access network services via the private access network. However, when the authorized user is at other locations that are not proximate to the coverage region of the WAN, the hosting wireless router may cease advertising of the private access network. In particular, a communications network 125 is presented for providing broadband access in the broadband access network domain 110 to a plurality of data terminals 114 via access terminal 112, wireless access in the wireless access network domain 120 to a plurality of mobile devices 124 and vehicle 126 via base station or access point 122, voice access in the voice access network domain 130 to a plurality of telephony devices 134, via switching device 132 and/or media access in the media access network domain 140 to a plurality of audio/video display devices 144 via media terminal 142. In addition, communication network 125 is coupled to one or more content sources 175 of audio, video, graphics, text and/or other media. While the broadband access network domain 110, the wireless access network domain 120, the voice access network domain 130 and the media access network domain 140 are shown separately, one or more of these forms of access can be combined to provide multiple access network domains providing multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access via the broadband access network domain 110, wireless access via the wireless access network domain 120, voice access via the voice access network domain 130, media access via the media access network domain 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the networking system 100 can include a controllable network enablement system that can be configured for operability in one or more of the broadband access network domain 110, the wireless access network domain 120, the voice access network domain 130, and/or the media access network domain 140. For example, the controllable network enablement system can include a network access manager 180 configured to control an availability an access network as may be operable in one or more of the example network domains 110, 120, 130, 140. In at least some embodiments, availability of the access network may be controlled by enabling and/or disabling the access network based on at least one condition, rule and/or policy.

According to the illustrative example, the broadband access network domain 110 includes a broadband access terminal controller 182 that can be configured to control accessibility to at least a portion of the broadband access network domain 110 via the access terminal 112. In at least some embodiments, the broadband access terminal controller 182a is in communication with the network access manager 180 and operable to enable and/or disable the broadband access network domain 110, e.g., according to an indication received from the network access manager 180. In at least some embodiments, the network access manager 180 determines a location of a first user 186a with respect to a location and/or region proximate to broadband access network domain 110. In at least some embodiments, proximity may be determined according to a location and/or geographic location, e.g., a building, a floor, a suite and/or a room containing the access terminal 112.

For example, the location of the first user may be obtained from a location of user equipment, such as a smart phone, a smart watch, a tablet device, an internet of things (IoT) device that may be presumed to be in possession of the user, and the like. In at least some embodiments, a first smart phone 184a of the first user 186a can host an application that self-reports a location of the first smart phone 184a to the network access manager 180. Location may include any one or more of geocoordinates, e.g., a latitude, a longitude and/or an elevation, an address, a private facility, such as a business or home location, a vehicle, a public facility, such as a school, a hotel, and the like. Upon determining a location of the first user 186a as may be inferred from a location of the smart phone 184a, the network access manager 180 may implement one or more rules and/or policies configured to permit and/or deny operability of the access terminal 112, e.g., restricting access to anyone based on a location of the first user 186a. In at least some embodiments, access may be permitted by enabling the broadband access network domain 110, e.g., by enabling the access terminal 112. Alternatively, access may be restricted by disabling the broadband access network domain 110, e.g., by disabling the access terminal 112. A greater level of security can be realized by effectively turning off, shutting down and/or otherwise disabling the broadband access network domain 110 unless the first user 184a is determined to be at and/or nearby to the access terminal 112. Such a disabling of the access terminal 112 removes any opportunity for unauthorized users to attempt to gain unauthorized access to the broadband access network domain 110, e.g., via the access terminal 112, and/or to other devices and/or systems via the broadband access network domain 110.

In at least some embodiments, similar provisions can be provided in one or more of the other access network domains 120, 130, 140. For example, the wireless access network domain 120 can include a wireless access terminal controller 182b that can be configured to enable and/or disable at least a portion of the wireless access network domain 120 via the base station or access point 122 responsive to an indication from the network access manager 180, e.g., based on a location of a second user 186b as may be inferred from a personal communication device 184b of the second user 186b. Likewise, the voice access network domain 130 can include a voice access terminal controller 182c that can be configured to enable and/or disable at least a portion of the voice access network domain 130, e.g., via the switching device 132. For example, the voice access terminal controller 182c can be configured to enable and/or disable at least a portion of the voice access network domain 130 via the switching device 132 responsive to an indication from the network access manager 180, e.g., based on a location of a third user 186c as may be inferred from a personal communication device 184c of the third user 186c. Similarly, the media access network domain 140 can include a media access terminal controller 182d that can be configured to enable and/or disable at least a portion of the media access network domain 140, e.g., via the media terminal 142. For example, the media access terminal controller 182d can be configured to enable and/or disable at least a portion of the media access network domain 140, e.g., via the media terminal 142 responsive to an indication from the network access manager 180, e.g., based on a location of a fourth user 186d as may be inferred from a personal communication device 184d of the fourth user 186c.

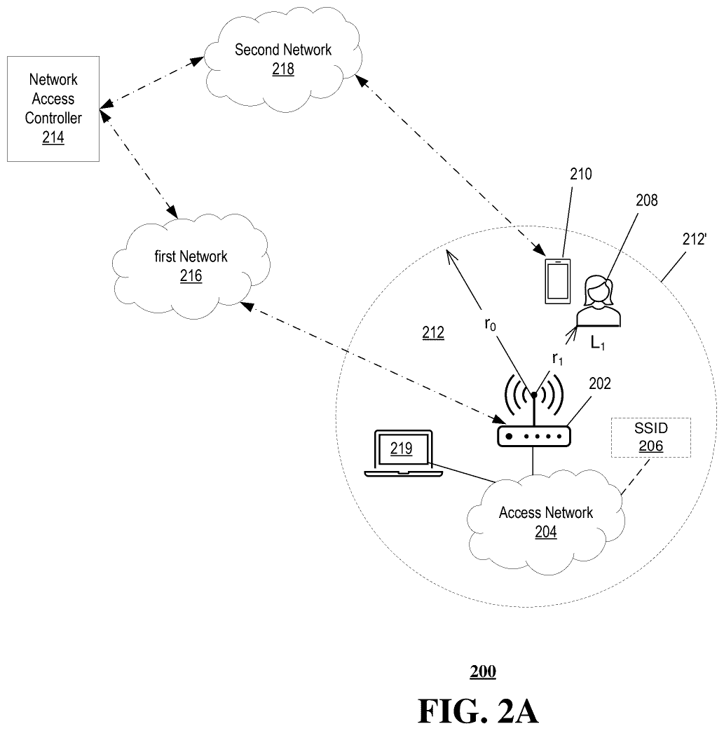

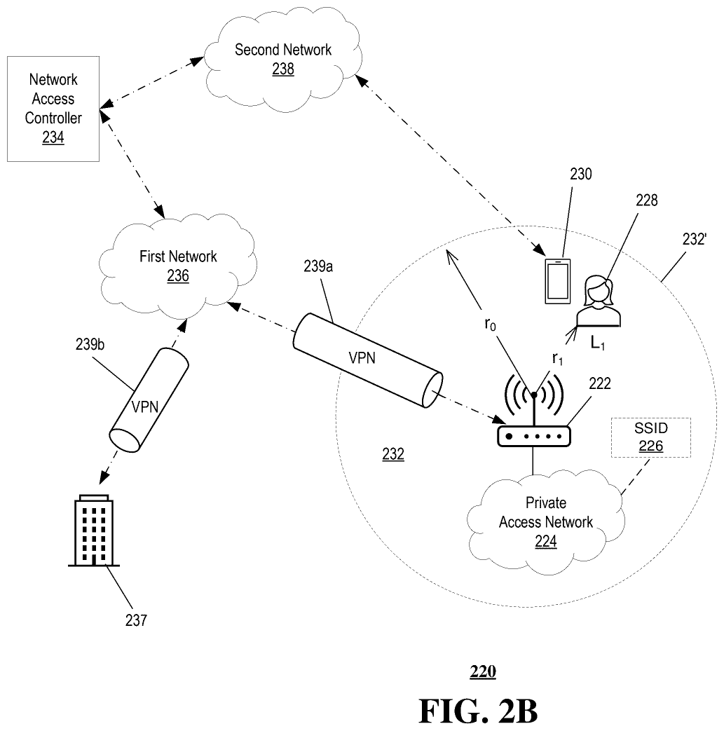

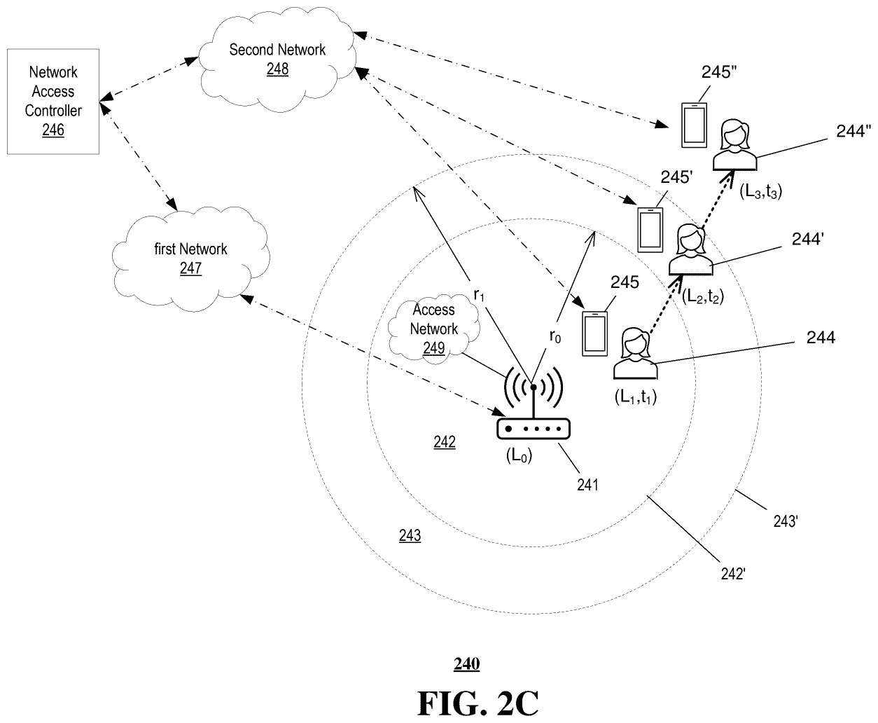

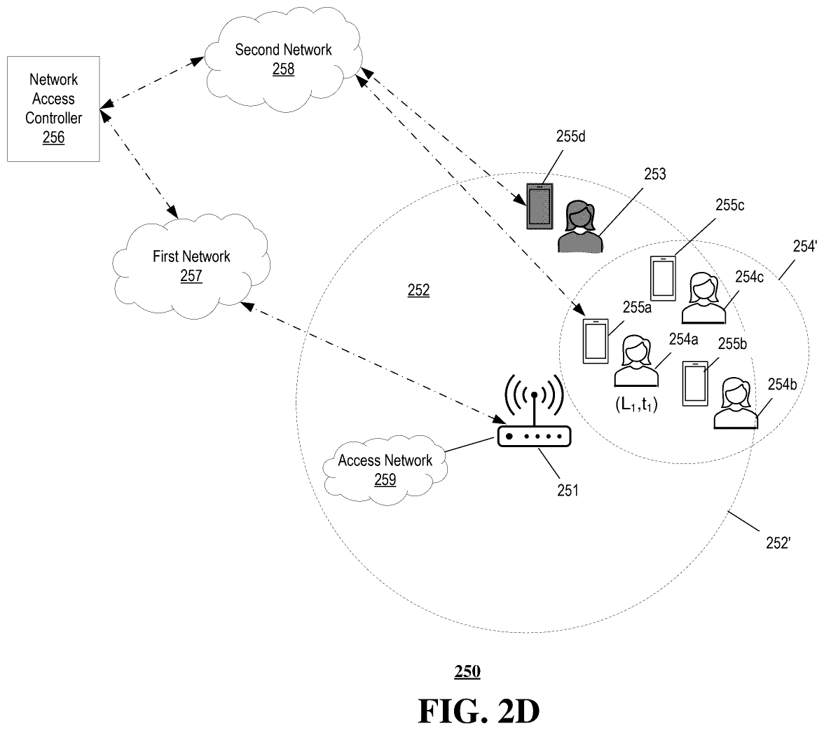

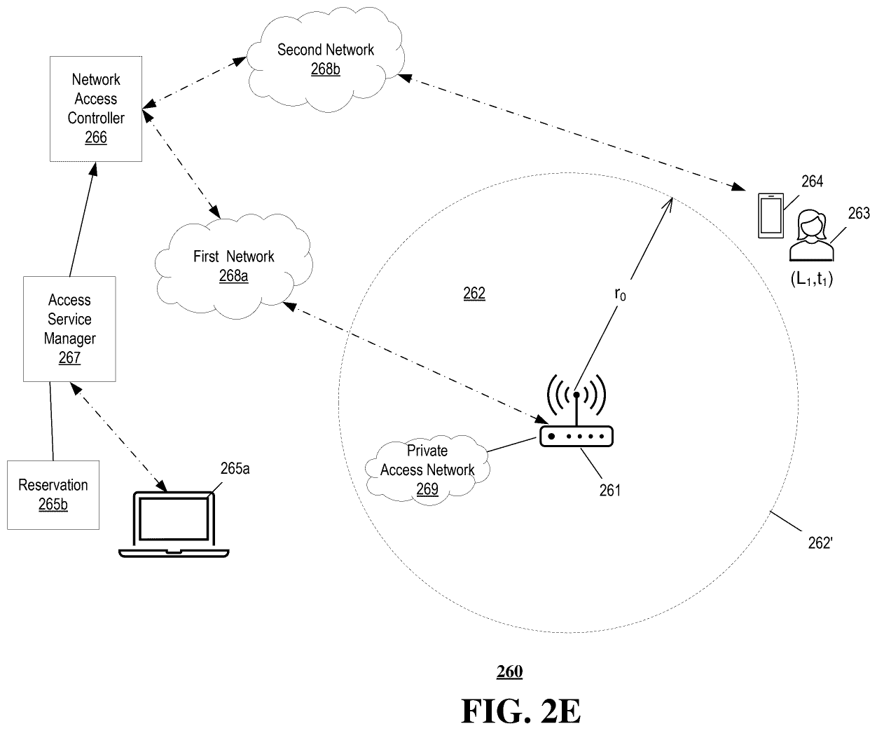

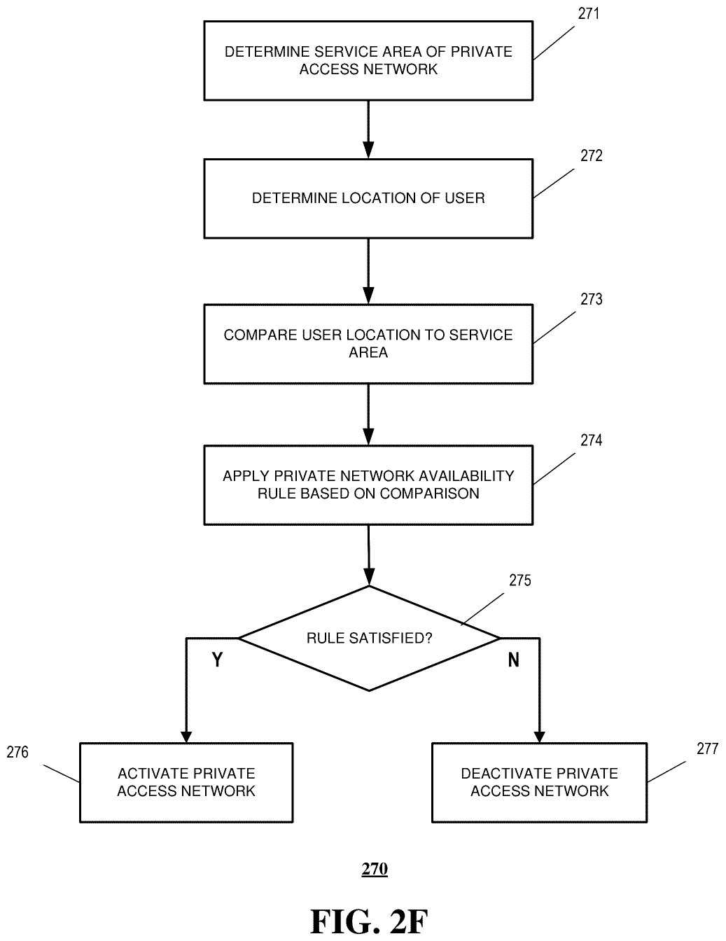

FIG. 2A is a block diagram illustrating an example, non-limiting embodiment of a controllable network enablement system 200 functioning within the networking system 100 of FIG. 1 in accordance with various aspects described herein. The controllable network enablement system 200 includes a network access device 202 configured to control an availability and/or enablement of an access network 204. The network access device 202 can include a network device, such as a wireless modem, a router, e.g., a wireless router, a switch, a bridge, a gateway server, and the like. In at least some embodiments, the network access device 202 is operable to control an access network 204 between an active state in which the access network 204 is available and/or otherwise enabled for network service at a first location, e.g., within a network availability region 212, and an inactive state in which the private access network is unavailable and/or otherwise disabled for service at the first location. Without limitation, the availability and/or enablement of the access network can be controlled by one or more of an activation and/or deactivation of the access network 204, an enablement and/or disablement of the access network 204, a revealing and/or concealing of the access network 204, a publicizing and/or hiding the access network 204 and/or an advertising and/or a preventing of advertisement of the access network 204.

In at least some embodiments, the access network 204 includes a network that can be identified according to a network identifier (ID), such as a network name. By way of example, the access network 204 can include a wireless access network, e.g., a wireless local area network (LAN) according to any of the IEEE 802.11 standards. In at least some embodiments, the access network 204 includes a wireless LAN adopting a Wi-Fi wireless network protocol that can be identified according to an associated service set identifier (SSID) 206. For example, the network access device 202 can expose the SSID 206 in such a manner as to allow wireless terminal devices 219 to discover and/or otherwise become aware of an existence, a presence, an availability, etc., of the access network 204 by way of its SSID 206.

In at least some scenarios, the network access device 202 can be configured to host, enable, and/or otherwise support the wireless network associated with the SSID 206. To this end, the network access device 202 may advertise the existence of the access network 204 by exposing its SSID 206 to other wireless terminal devices 219 and/or user equipment 210 located within the network availability region 212. It is understood that in some instances, the advertised Wi-Fi network may be generally accessible to the public, e.g., including any Wi-Fi enabled device within the network availability region 212. In other instances, the advertised Wi-Fi network may be private in that access to the advertised network may be protected and/or otherwise secured to control and/or otherwise restrict access. For example, access to a private Wi-Fi network may be limited to authorized users, e.g., those users possessing suitable credentials, such as passwords. In at least some embodiments, access to private Wi-Fi networks may be restricted by using one or more of Wired Equivalent Privacy (WEP), Wi-Fi Protected Access (WPA), WPA2, and the like.

In at least some embodiments, the network availability region 212 can be defined and/or otherwise determined according to a distance or service range, e.g., an approximate distance or maximum service range r₀, e.g., measured from a position or location of the network access device 202. In at least some embodiments, the service range may be determined according to a wireless range approximating an area in which wireless access is achievable. It is understood that in at least some applications, the service range(s) may not be uniform, e.g., being determined according to one or more of a radio frequency (RF) power or signal level, an operational frequency and/or a frequency band, a spectrum management policy, local terrain ad may include obstructions, minimum receive power or signal level, e.g., receiver sensitivities, and the like. In at least some scenarios, the size, shape and/or general extent of the network availability region 212 may be differ between an uplink, e.g., transmitting from the wireless terminal device 219 or user equipment 210 to the network access device 202 and a downlink, e.g., transmitting in the opposite direction. With this understanding, references to a location of the access network 204 can be approximated by a position or location of the network access device 202, e.g., by way of positional coordinates, e.g., geocoordinates, and/or an address, e.g., a location of a building, a suite of rooms within a building, a particular room, an elevation or floor level, an equipment rack, and so on. Alternatively, or in addition, the position or location of the network access device 202 can be approximated by a location, size and/or shape of the network availability region 212. For example, a location of the example access network 203 may be determined according to a perimeter and/or coverage boundary 212′ of the service availability region. In some embodiments, the coverage boundary 212′ can be approximated by a circle defined at the maximum service range r₀ of the network availability region 212 and centered at a position or location of the network access device 202. Alternatively, or in addition, the coverage boundary 212′ may be determined and/or otherwise described as a shape on a grid or map. The shape may be determined according to a resulting wireless coverage pattern.

According to the illustrative example, the controllable network availability system 200 includes a network access controller 214 communicatively coupled to the network access device 202, e.g., via first network 216. In at least some embodiments, the network access controller 214 may be configured to provide instructions or commands, e.g., indications, signals and/or messages, to the network access device 202. At least one command can be configured to cause the network access device 202 to activate and/or otherwise enable the access network 204. Similarly, another command can be configured to cause the network access device 202 to deactivate and/or otherwise disable the access network 204. Continuing with the illustrative example in which the access network 204 provides a wireless network, e.g., a Wi-Fi network, activation and/or enablement can be achieved by advertising an SSID of the Wi-Fi network. Alternatively, or in addition, deactivation and/or disablement of the Wi-Fi network can be achieved by removing advertisement of the SSID. It is understood that in at least some embodiments, network equipment, such as the network access device 202 may require a provisioning of certain information, such as the SSID, authorization credentials, e.g., usernames and/or passwords as may be applied in one or more of WEP, WPA and/or WPA2 scenarios.

Further according to the illustrative example, the network access controller 214 may be remotely located from the network access device 202. For example, the network access controller 214 may be located beyond the coverage boundary 212′, e.g., being geographically remote from the location of the network access device 202. Alternatively, or in addition, the network access controller 214 may be located nearby to the network access device 202, e.g., within the coverage boundary 212′. In at least some embodiments, the network access controller 214 can be located at and/or internal to, e.g., integrated within the network access device 202. When the network access controller 214 is spaced apart from or separate from the network access device 202, it may be communicatively coupled thereto via a first network 216. Without limitation, the first network 216 can include a wide area network, such as the public Internet, a private networks, a wireless network, such as a mobility or cellular network, a wireless LAN, e.g., a Wi-Fi network, a Bluetooth network. Alternatively, or in addition the first network 216 can include a wired network, e.g., according to an Ethernet protocol and/or any other proprietary wired network protocol. Other wired networks can include, without limitation, leased communication lines, public telephone service, e.g., a basic wireline telephone service, a cable network, a fiber network, a dedicated wired link or cable, and/or any combination of the any of the foregoing wired and/or wireless communication networks and/or links.

In at least some embodiments, the network access controller 214 can be configured to activate, enable and/or otherwise provision the access network 204 according to an event and/or a condition. In at least some embodiments, the event and/or condition is determined according to location information, such as a location of at least one individual 208 and/or equipment, such as the example terminal devices 219 and/or user equipment 210. According to the illustrative example, the condition can include a proximity of the individual 208 to the network availability region 212. For example, the network access controller 214 can determine an indication of a location of the individual 208. The network access controller 214 can then compare the location of the individual 208 to the network availability region 212 to determine if the individual 208 is within the network availability region 212 and/or at least nearby. The network access controller 214 can be configured to provide an instruction or command to the network access device 202 to activate and/or otherwise enable the access network 204, e.g., by advertising a Wi-Fi network. Once activated and/or enabled, the access network 204 may become discoverable and/or otherwise accessible to the individual 208 once located within the coverage boundary 212′, e.g., via the wireless terminal devices 219 and/or the user equipment 210. Should a comparison indicate that the individual 208 is not within the network availability region 212 and/or beyond some buffer zone extending to some degree beyond the coverage boundary 212′, the network access controller 214 can be configured to provide another instruction or command to the network access device 202 to deactivate and/or otherwise disable the access network 204, e.g., by removing any advertisement of the Wi-Fi network. Once deactivated and/or disabled, the access network 204 may become undiscoverable and/or otherwise inaccessible to the individual 208 or anyone else.

It is envisioned that a location of the individual 208 may be determined by one or more user equipment 210 or devices in possession of the individual 208 and/or otherwise reliably known to be nearby to the individual 208. In at least some embodiments, user equipment 210, such as a mobile device, e.g., a smartphone, a smartwatch, a tablet device, a laptop computer, an intelligent garment and/or accessory, e.g., smart glasses may be configured to report a location of the user equipment 210. Alternatively, or in addition, the user equipment may include a smart vehicle and/or an Internet of Things (IoT) device as may be reliably understood to be proximate to the individual 208 and as such serve as an indication of a location of the individual 208. Accordingly, a location of the user may be inferred from the location of the user equipment 210, as may be determined via communications with the user equipment 210, e.g., via the first network 216 and/or via a second network, such as a mobility network 218.

In at least some embodiments, the location may be obtained via a location receiver of a smart device, e.g., a GPS receiver of the user equipment 210. Alternatively, or in addition, the location of the user equipment 210 may be provided by a network service provider or other third party, such as a mobile network service provider. The network service provider and/or other third party may determine an estimate of the location of the user equipment 210 by using any suitable means, such as proximity to one or more wireless access points, relative signal strengths and/or signal delays determined according to wireless signals exchanged with the user equipment 210.

In at least some embodiments, the network access controller 214 compares the location of the individual 208, e.g., as determined according to a location of the user equipment 210, to the network availability region 212. In at least some embodiments, a proximity of the individual 208 to a position of the network access device 202 can be determined by comparing a determined and/or otherwise reported position or location of the individual 208 to a position or location of the network access device 202. An approximate separation distance r₁ may be determined between the two positions or locations, and the distance may be compared to a threshold value. For example, the threshold value may be determined according to the maximum service range r₀. In at least some embodiments, the network access controller 214 may determine and/or otherwise conclude that the individual 208 is sufficiently close to the network availability region 212 according to a difference between the separation distance and the range, e.g., to the extent the condition r₁−r₀≤0 is true. In such instances, the network access controller 214 can provide an instruction and/or command to the network access device 202 to cause an activation and/or enablement of the access network 204. Alternatively, to the extent the condition r₁−r₀≤0 is false, the network access controller 214 can provide an instruction and/or command to the network access device 202 to cause a deactivation and/or disablement of the access network 204.

In at least some embodiments, a condition regarding proximity of an individual 208 to the network availability region 212 may be determined by comparing a location of the individual 208 to the coverage boundary 212′. In at least some embodiments, this comparison may be determined graphically, e.g., plotting the location of the individual 208 on a graph including a plot of the coverage boundary 212′. Once plotted, a proximity condition may be determined according to the plotted position or location of the individual 208 residing within or without the plotted coverage boundary 212′, or perhaps within some predetermined buffer region extending beyond the coverage boundary 212′.

In at least some embodiments, the command may be provided responsive to a change in a result of the condition r₁−r₀≤0. For example, the network access controller 214, upon detecting a transition from false to true, can provide an instruction and/or command to the network access device 202 to initiate activation and/or enablement of the access network 204. Alternatively, or in addition, upon detecting a transition from false to true, the network access controller 214 can provide the instruction and/or command to the network access device 202 to initiate deactivation and/or disablement of the access network 204.

In at least some embodiments, positions of one or more of the user equipment 210 and/or the network access device 202 may be determined according to some strategy that considers updates that permit a substantially current determination as to proximity of the individual 208 and the network availability region 212 may be determined. For example, one or more of the positions may be determined according to a schedule, e.g., periodically according to some time interval, e.g., some number of seconds, minutes and/or hours. Alternatively, or in addition, one or more of the positions may be determined according to an event, such as a message of opportunity between the user equipment 210 and the second network 218, between the user equipment 210 and the network access controller 214 and/or between the user equipment 210 and the network access device.

In at least some embodiments, the distance measurements may be paused and/or otherwise ignored while the user equipment 210 is in communication with an activated and/or otherwise enabled access network 204. For example, it can be inferred from this scenario that the user equipment 210 is nearby, because it is within the network availability region 212 as evidenced by communications via the access network 204, without necessarily obtaining a current location of the user equipment 210. Alternatively, or in addition, the communications via the access network 204 may include position information of the user equipment 210, e.g., including self-reported position information.

In at least some embodiments, after having determined the user equipment 210 is sufficiently close to and/or within the network availability region 212, the network access controller 214 may draw inference from a pause and/or cessation of any communications between the user equipment 210 and the network access device 202 that a location of the user equipment 210 may no longer satisfy a proximity requirement, without necessarily obtaining a current location of the user equipment 210. In at least some embodiments, the network access controller 214 may provide an updated instruction and/or command to the network access device 202 resulting in a deactivation and/or disablement of the access network 204. In at least some embodiments, after having drawn an inference that a location of the user equipment 210 is no longer satisfies a proximity requirement, the network access controller 214 may revert to determining a location of the user equipment 210 from any other suitable means to permit an independent determination as to whether a proximity of the user equipment 210 to the network access device 202 is satisfied, with an appropriate instruction and/or command being issued.

In at least some embodiments, a deactivation and/or disablement of a currently active and/or otherwise enabled access network 204 may be subject to another condition, such as a time delay. For example, deactivation of a formerly active access network 204 responsive to an inference and/or a determination that the condition r₁−r₀≤0 is no longer satisfied, may be initiated after an expiration of a time interval or delay. Such a delay may be predetermined according to some number of seconds, minutes and/or hours. In at least some embodiments, a value of the delay may depend on yet another condition. For example, the condition may relate to one or more applications, e.g., voice, versus streaming, versus file transfer, versus texting, etc., which may result in application of a respective delay. Alternatively, or in addition, the condition may relate to an identity of the user and/or a corresponding subscription level, e.g., of a subscription level of mobile services and/or an access network subscription. In at least some embodiments, the condition may relate to a time of day, a day of week and/or some other event that may be occurring nearby. Consider the delays being applied differently between working hours and after hours, or between weekdays and weekends, or during scheduled events, such as sporting events, shows, business meetings, and the like as may be determined according to a calendar and/or schedule. Still other conditions may relate to threat levels, proximities of other users, and so on.

It is understood that in at least some embodiments, the network access controller 214 may be configured to provide a notification and/or an alarm responsive to an activation and/or deactivation of the access network 204. For example, the network access controller may initiate a communication to the user equipment 210 responsive to a determination that the user equipment 210 may have moved out of the network availability region 212. The notice may ask whether the user intended to leave the network availability region 212, e.g., soliciting a response from the individual 208. The network access controller 214 may then initiate deactivation of the access network and/or establish a delay based on the user's reply, e.g., a delay being established and/or extended based on a likelihood and/or expressed intention that the individual 208 will return.

FIG. 2B is a block diagram illustrating an example, non-limiting embodiment of another controllable network enablement system 220 functioning within the networking system 100 of FIG. 1 in accordance with various aspects described herein. Employees often utilize virtual private network (VPN) connections when working off-site. For example, each individual employee may use a separate VPN client to establish a separate VPN connection that terminates at an enterprise location, such as a VPN server on an enterprise network at a company's home location. In this case, all traffic, including traffic sent between the employees'devices, must travel through the enterprise network.

According to the illustrative example, the controllable network enablement system 220 includes a network access device 222 configured to activate, enable and/or otherwise host a private access network 224. The private access network 224 can include a wireless access network, such as the example Wi-Fi networks disclosed herein. Accordingly, the private access network 224 is configured to provide network service or availability to network services within a network availability region 232 as may be defined by a network services range 232′, e.g., determined by a maximum service range r₀. In at least some embodiments, the controllable network enablement system 220 includes a network access controller 234 that may be in communication with the network access device 222, e.g., via a first network 236, e.g., the public Internet. In at least some embodiments, the network access controller 234 can be configured to determine a proximity of an individual, e.g., an employee 228 to the network access device 222.

For example, the employee 228 possesses user equipment 230, e.g., a mobile device, such as a smartphone that may be configured with an application that reports a location of the user equipment 230 to the network access controller 234. In at least some embodiments, the application hosted on the user equipment 230 may communicate with the network access controller 234 via a second network 238, e.g., a mobility or cellular network, such as an LTE, 4G or 5G network. The application may determine an approximate location of the user equipment 230 as obtained via a location receiver of the user equipment, e.g., a GPS receiver. Alternatively, or in addition, the application may determine an approximate location as reported by a mobile network service provider, e.g., determined by mobile network resources, such as WAPs and/or cell towers.

The network access controller 234 may be configured with an approximate position and/or location of the network access device. For example, the employee 228 may register a location of a home network access device 222 and/or a remote location, such as a remote business location, airport, café, and/or hotel. The network access controller 234 may determine a proximity condition as to whether the employee 228 is within and/or sufficient close to the network availability region 232, e.g., by comparing location data of the user equipment to registered position and/or location data of the network access device 222. To the extent that the proximity condition is satisfied, the network access controller 234 sends an instruction to the network access device 222 to activate and/or otherwise enable the private access network 224. In at least some embodiments, activation and/or enablement of a Wi-Fi enabled private access network 224 can be achieved by advertising an SSID 226 of the private access network 224.

In at least some embodiments, activation and/or enablement of the private access network 224 may further include establishment of a VPN. According to the illustrative example, a VPN 239a, 239b may be established between the network access device 222 and/or the user equipment 230 itself, and an enterprise network at a company's home location 237. The VPN 239a, 239b facilitates secure communications between the network access device 222 and/or the user equipment 230 and the enterprise network at the company's home location 237.

In at least some embodiments, the network access device is a portable device that may be carried by the employee 228 to facilitate establishment of the VPN 239a, 239b from different locations as may be beneficial for a mobile employee 228. In such instances, a location of the network access device 222 may be determined according to one or more techniques. For example, the employee 228 may report a location of the network access device 222 during a configuration process as may be facilitated by an application hosted on the user equipment 230. Consider an employee 228 arrives at a remote business destination. The employee 228 may use the application to record an address of the portable network access device 222. The address may be determined according to a then current location of the user equipment 230, e.g., as obtained from a GPS receiver and/or as reported by a mobile network operator. Alternatively, or in addition, the position or location may be determined according to a reported address, facility location, building, suite of rooms, room, floor, etc.

It is envisioned that within at least some embodiments, a position of the portable network access device 222 and/or the employee 228 may be inferred from another source, such as a calendar. If an employee's calendar indicates the employee is at a particular remote business location during a particular period of time, that location may be used by the network access controller 234 in determining a proximity condition. Accordingly, the portable network access device 222 in cooperation with the network access controller 234 enhances network security by only activating and/or otherwise enabling the private access network 224 when the employee 228 is within and/or near the network availability region 232, wherever that region may exist.

FIG. 2C is a block diagram illustrating an example, non-limiting embodiment of another controllable network enablement system 240 functioning within the networking system 100 of FIG. 1 in accordance with various aspects described herein. In particular, the illustrative example addresses operation of the controllable network enablement system 240 responsive to different proximities between a user and an access network location and/or movement of authorized users with respect to the access network location.

According to the illustrative example, the controllable network enablement system 240 includes a network access device 241 configured to activate, enable and/or otherwise host a private access network 249. The private access network 249 can include a wireless access network, such as the example Wi-Fi networks disclosed herein. Accordingly, the private access network 249 is configured to provide network service or availability to network services within a network availability region 242 as may be defined by a network services range 242′, e.g., determined by a maximum service range r₀.

In at least some embodiments, the controllable network enablement system 240 includes a network access controller 246 that may be in communication with the network access device 241, e.g., via a first network 247, e.g., the public Internet. In at least some embodiments, the network access controller 241 can be configured to determine a proximity of an individual 244 to the network access device 241. According to the illustrative example, the network access controller 241 can infer a location of the individual 244 from a location of user equipment 245 associated with the individual 244. The location of the user equipment 245 may be determined according to any of the various techniques disclosed herein and/or otherwise generally known. Likewise, the network access controller 241 can determine a location of the network access device 241, e.g., as determined during a registration and/or configuration process as may be performed in support of the example proximity access restriction service.

For example, the individual 244 possesses user equipment 245, e.g., a mobile device, such as a smartphone that may be configured with an application that reports a location of the user equipment 245 to the network access controller 246. In at least some embodiments, the application hosted on the user equipment 245 may communicate with the network access controller 246 via a second network 248, e.g., a mobility or cellular network, such as an LTE, 4G or 5G network. In at least some embodiments, the first and second networks 247, 248 may be the same, e.g., a single network. The application may determine an approximate location of the user equipment 245 as obtained via a location receiver of the user equipment, e.g., a GPS receiver. Alternatively, or in addition, the application may determine an approximate location as reported by a mobile network service provider, e.g., determined by mobile network resources, such as WAPs and/or cell towers.

Further according to the illustrative example, the individual 244 is at a first location L₁ at a first time t₁. The first location L₁ may be reported to the network access controller 246, which in turn may compare the location L₁ to a predetermined position or location L₀ of the network access device 241. According to the comparison, e.g., L₁−L₀ the network access controller can determine a proximity condition between the individual 244 and the network access device 241. For example, at the first time t₁, a first proximity condition L₁−L₀<r₀ is true. Accordingly, the network access device 241 may cause the network access device 241 to manage activation and/or enablement of the access network 249 according to a first set of rules and/or policies. For example, the network access controller 246 may activate and/or otherwise enable the access network 249 in response to the first condition being true.

At a later time t₂, such that t₂>t₁, however, the individual 244′ may have moved to a different location L₂. At the second time t₂, an updated proximity comparison may be reevaluated to obtain a second proximity condition L₂−L₀<r₀, which in this instance would be false. In at least some embodiments, the network access device 241 may cause the network access device 241 manage activation and/or enablement of the access network 249 according to a second set of rules and/or policies, e.g., to deactivate and/or otherwise disable the access network 249. In at least some embodiments, the second set of rules and/or policies may cause the network access controller 246 to evaluate a third condition with respect to a buffer region 243, e.g., defined by a buffer range 243′ r₁. The buffer region 243 may be established to extend to some limited distance beyond the network service range 242′. Such a buffer region 243 may be used to manage situations in which the individual 244 is operating at an edge of service to prevent the network access controller from unnecessarily causing the network access device 241 to deactivate and/or otherwise disable the access network 249.

According to the illustrative example, the buffer region 243 extends between the network service range 242′ and the buffer range 243′. By way of example, the third proximity condition may be determined according to r₀<L₂−L₀<r₁. To the extent the third condition is true, the network access controller 246 may determine that the individual 244′ is beyond the network service range 242′ yet still within the buffer range 243′. The network access controller 246 may be configured to cause the network access device 241 to manage activation and/or enablement of the access network 249 according to a third set of rules and/or policies. For example, the network access controller 246 may be configured to refrain from deactivating and/or otherwise disabling an activated and/or enabled access network 240, e.g., no further instructions are provided to the network access device 241. Alternatively, or in addition, the network access controller 246 may be configured to activate and/or otherwise enable a deactivated and/or disabled access network 240, e.g., providing instructions the network access device 241 to activate and/or enable the access network 249. Such an occurrence may facilitate operation for an individual 244′ moving in an opposite direction, e.g., from location L₂ to location L₁. Still other rules and/or policies may impose activation of a timer, e.g., adding a delay before any activation and/or deactivation instructions are provided.

At yet another later time t₃, such that t₃>t₂>t₁, however, the individual 244″ may have moved to yet another different location L₃. At the third time t₃, an updated proximity comparison may be reevaluated to obtain a fourth proximity condition L₃>r₁, which in this instance would be true. In at least some embodiments, the network access device 241 may cause the network access device 241 manage activation and/or enablement of the access network 249 according to a third set of rules and/or policies, e.g., to deactivate and/or otherwise disable the access network 249. In at least some embodiments, the third set of rules and/or policies may cause the network access controller 246 to evaluate the fourth proximity condition with respect to a buffer region 243, e.g., defined by a buffer range 243′ r₁.

FIG. 2D is a block diagram illustrating an example, non-limiting embodiment of another controllable network enablement system 250 functioning within the networking system 100 of FIG. 1 in accordance with various aspects described herein. In particular, the illustrative example addresses operation of the controllable network enablement system 250 responsive to different users and/or groups of users.

According to the illustrative example, the controllable network enablement system 250 includes a network access device 251 configured to activate, enable and/or otherwise host a private access network 259. The private access network 259 can include a wireless access network, such as the example Wi-Fi networks disclosed herein. Accordingly, the private access network 259 is configured to provide network service or availability to network services within a network availability region 252 as may be defined by a network services range 252′, e.g., determined by a maximum service range r₀.

In at least some embodiments, the controllable network enablement system 250 includes a network access controller 256 that may be in communication with the network access device 251, e.g., via a first network 257, e.g., the public Internet. In at least some embodiments, the network access controller 256 can be configured to determine a proximity of any member of an authorized group of users 254′ to the network access device 241. According to the illustrative example, the authorized group of users 254′ includes a first user 254a in possession of first user equipment 255a, a second user 254b in possession of second user equipment 255b, a third user in passion of third user equipment 254c. In at least some embodiments, one or more of the user equipment 255a, 255b, 255c may communicate with the network access controller 256 via a second network 258, e.g., a mobility or cellular network, such as an LTE, 4G or 5G network. In at least some embodiments, the first and second networks 247, 248 may be the same, e.g., a single network. The network access controller 256 can infer a location of the individual users 254a, 254b, 254c, generally 254, from locations of the user equipment 255a, 255b, 255c, generally 255. The location of the user equipment 255 may be determined according to any of the various techniques disclosed herein and/or otherwise generally known. Likewise, the network access controller 256 can determine a location of the network access device 251, e.g., as determined during a registration and/or configuration process as may be performed in support of the example proximity access restriction service.

According to the illustrative example, the network access controller 256 can cause the network access device 251 to activate and/or deactivate and/or otherwise enable and/or disable the private access network 259 responsive to one or more rules and/or policies determined according to individual users 254 and/or the authorized group of users 254′. For example, the network access controller 256 may be configured cause the network access device 251 to activate and/or otherwise enable the private access network 259 responsive to any one or more individuals 254 of the authorized group of users 254′ being within the network availability region 252 and/or some predetermined buffer region. Alternatively, or in addition, the network access controller 256 may be configured cause the network access device 251 to deactivate and/or otherwise disable the private access network 259 only responsive to all individuals 254 of the authorized group of users 254′ being outside of the network availability region 252 and/or outside of some predetermined buffer region.

It is envisioned further that there may be one or more other users identified as unauthorized users and/or one or more other user equipment identified as unauthorized user equipment. According to the illustrative embodiment, an unauthorized user 253 is in possession of user equipment 255d. It is understood that the network access controller 256 may be configured with one or more rules and/or policies to cause the network access device 251 to control activation and/or enablement of the private access network 259 according to proximities of the unauthorized user 253 and/or the unauthorized user equipment 255d. It is understood that unauthorized user equipment 255d may be determined independently with respect to a user. That is, an authorized user 254a may be in possession of authorized user equipment 255a and/or unauthorized equipment 255d. Accordingly, the network access controller 256 can implement a logic according to the rules and/or policies to determine whether the private access network 259 should be activated and/or deactivated. In at least some embodiments, deactivation may be imposed upon a proximity of the unauthorized user 253 and/or unauthorized user equipment 255d without regard to proximity of members of the authorized group of users 254′. It is envisioned further that unauthorized users 253 may be further categorized according to grades, risks and/or severity, such that any imposed rules and/or policies may take into account such different categories, e.g., implementing different rules and/or policies according to an applicable category of unauthorized user 253 and/or user equipment 255d

FIG. 2E is a block diagram illustrating an example, non-limiting embodiment of another controllable network enablement system 260 functioning within the networking system 100 of FIG. 1 in accordance with various aspects described herein. In particular, the illustrative example addresses operation of the controllable network enablement system 260 responsive to projecting and/or otherwise provisioning a third-party, private access network 269 to a particular location, at which activation and/or enablement of the private access network 269 may be managed according to proximity information of individuals 263 and/or user equipment 264. In at least some embodiments, the user equipment 664 may communicate with the network access controller 266 via a second network 268b, e.g., a mobility or cellular network, such as an LTE, 4G or 5G network.

According to the illustrative example, the controllable network enablement system 260 includes a host's network access device 261 configured to activate, enable and/or otherwise host the third-party, private access network 269. The third-party, private access network 269 can include a wireless access network, such as the example Wi-Fi networks disclosed herein. Accordingly, the third-party, private access network 269 is configured to provide network service or availability to network services within a network availability region 262 as may be defined by a network services range 262′, e.g., determined by a maximum service range r₀.

In at least some embodiments, the controllable network enablement system 260 includes a network access controller 266 that may be in communication with the host's network access device 261, e.g., via a first network 268a, e.g., the public Internet. In at least some embodiments, the network access controller 266 can be configured to determine a proximity of an individual 263, e.g., an authorized user to the hosts network access device 261 and/or the network availability region 262.

According to the illustrative example, the individual 263 represents an authorized user who is in possession of user equipment 264. The network access controller 266 can infer a location of the individual 263 from a location L₁ of the user equipment 264. The location of the user equipment 264 may be determined according to any of the various techniques disclosed herein and/or otherwise generally known. Likewise, the network access controller 266 can determine a location of the host's network access device 261, e.g., as determined during a registration and/or configuration process as may be performed in support of the example proximity access restriction service.

According to the illustrative example, the host's network access device 261 may correspond to a wireless modem and/or WAP of a selectable hosting location. For example, the hosting location may correspond to a remote business facility, e.g., a facility of a subcontractor or vendor retained by another business, which may be an employer of the individual 263. The individual 263 and/or the employer, in preparation for a visit to the vendor facility, may coordinate with the vendor to permit the individual 263 to configure a vendor WAP to provide access to the third-party, private access network 269 of the employer. In another example, the location may correspond to a hotel and/or an Airbnb® short term rental property. In such instances, the host facility, e.g., the hotel or rental property may allow a guest to configure a host's WAP to activate a guest's private network in coordination with a reservation. Other examples may include activating a WAP of a conference room within a facility to host and/or otherwise support a user's private network in coordination with a scheduled meeting.

In at least some embodiments the controllable network enablement system 260 includes an access service manager 267. The access service manager 267 may be used to schedule and/or otherwise coordinate a temporary hosting of the third-party, private access network 269 on host equipment, such as the host's network access device 261. In operation, the access service manager may be in communication with a user access system 265a, e.g., hosting an application program and/or providing access to a Web portal associated with the access service manager 267. In at least some embodiments, the access service manager 267 may facilitate coordination of a scheduling of access to the host's network access device 261 in coordination with a reservation 265b concerning an individual.

In at least some embodiments, the access service manager 267 may be in further communication with the network access controller 266. The network access controller 266 may identify one or more of an identity of an authorized user, identification of a third-party, private access network 269, identification of a host, a host facility and/or a host's network access device 261. In at least some embodiments, one or more of the access service manager 267 and/or the network access controller 266 may cause, implement and/or otherwise support a temporary provisioning of the third-party access network 269 on the host's network access device 261. In at least some embodiments, such provisioning may include providing the host's network access device 261 with a name and/or SSID of the third-party, private access network 269. In at least some embodiments, provisioning may include providing other information, such as credentials, e.g., security passwords. It is understood that such provisioning of the host's network access device 261 may be accomplished in such a manner as to preserve privacy information, such as identification of the third-party, the credentials and so on.

Once provisioned, the host's network access device 261 may be operated to selectively activate and/or deactivate and/or enable and/or disable the third-party, private access network 269 according to proximity of an individual 263, proximity of authorized user equipment 264 alone and/or in coordination with one or more rules and/or policies as may be based on the proximity information. It is further understood that provisioning and/or deprovisioning may be performed according to a scheduled activity and/or an occurrence of an activity, e.g., check-in and/or check-out of an authorized user to a hotel and/or conference room hosting the third-party, private access network 269.

FIG. 2F depicts an illustrative embodiment of a process 270 for controlling enablement of a private access network in accordance with various aspects described herein. According to the example process 270, a determination may be made at 271 with respect to a private access network, to determine a service area associated with the private access network. According to the example process 270, a location of a user may be determined at 272. For example, a location of the user may be inferred based on a location of a user device associated with the user and/or a scheduled and/or otherwise reported location of the user as may be determined according to a calendar event and/or a reservation. The user location may be compared to the service area at 273, and a private network availability rule may be applied at 274 based on comparison. The rule and/or policy may be based on a proximity relationship between the user and a location of a network access device, such as a wireless modem or WAP.

According to the example process 270, a determine can be made at 275 as to whether the rule satisfied. For example, a network access controller may evaluate a proximity relationship, identify an applicable rule and/or policy, and apply the rule or policy to obtain a result. The result can be evaluated to determine whether the rule has been satisfied. To the extent it is determined at 275 that the rule is satisfied, the private access network may be activated at 276. For example, the network access controller may cause the network access device to activate and/or otherwise enable the private access network. Alternatively, to the extent it is determined at 275 that the rule is not satisfied, the network access controller may cause the network access device to deactivate and/or otherwise disable the private access network at 277.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

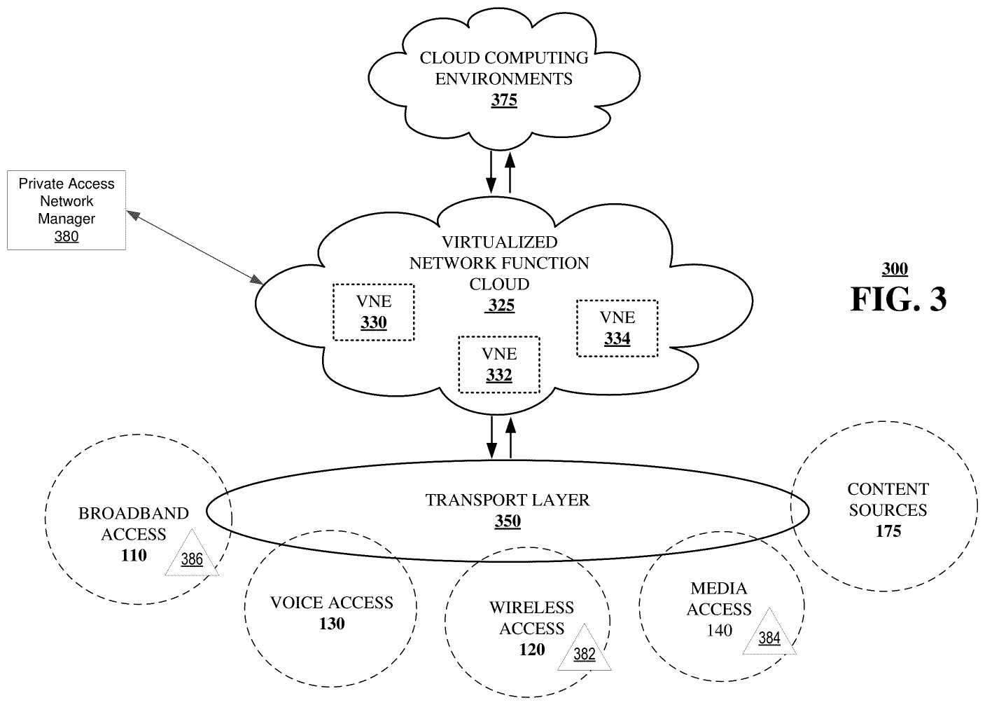

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of the networking system 100, the subsystems and functions of systems 200, 220, 240, 250, 260 and process 270 presented in FIGS. 1, 2A, 2B, 2C, 2D, 2E, 2F and 3. For example, virtualized communication network 300 can facilitate in whole or in part a control over an availability of a private access network. For example, a private access network, such as a wireless area network (WAN), e.g., a Wi-Fi network, may be configured to be available, or otherwise activated, based on a satisfaction of one or more rules related to a location of an authorized user. To the extent the rule(s) are not satisfied, the private access network can be controlled to an unavailable, or otherwise deactivated condition. For example, if the authorized user is at a location proximate to a coverage region of the WAN, a hosting wireless router can advertise the private access network, e.g., allowing the authorized user and/or any other authorized user to access network services via the private access network. However, when the authorized user is at other locations that are not proximate to the coverage region of the WAN, the hosting wireless router may cease advertising of the private access network.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access in a broadband access network domain 110, wireless access in a wireless access network domain 120, voice access in a voice access network domain 130, media access in a media access network domain 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

In at least some embodiments, the virtualized communication network 300 can include a private access network manager 380 that may be configured to cause private network access devices 382, 384, 386 in one or more different network access domains 110, 120, 140 to control activation and/or enablement of a private access network according to proximity information of one or more users who may be authorized and/or unauthorized and/or one or more user equipment who may be authorized and/or unauthorized.

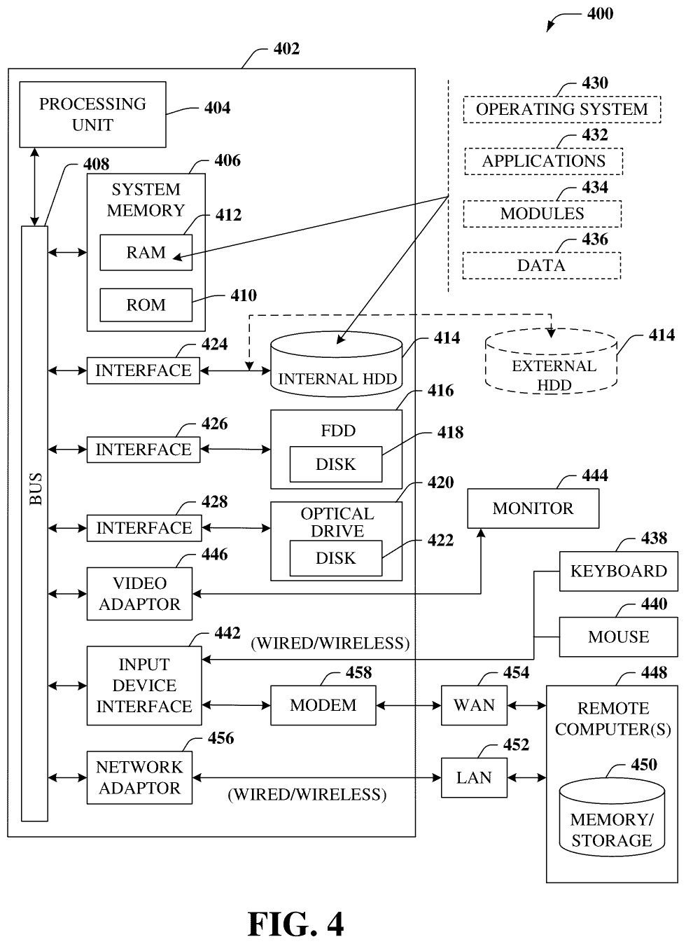

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part control over an availability of a private access network. For example, a private access network, such as a wireless area network (WAN), e.g., a Wi-Fi network, may be configured to be available, or otherwise activated, based on a satisfaction of one or more rules related to a location of an authorized user. To the extent the rule(s) are not satisfied, the private access network can be controlled to an unavailable, or otherwise deactivated condition. For example, if the authorized user is at a location proximate to a coverage region of the WAN, a hosting wireless router can advertise the private access network, e.g., allowing the authorized user and/or any other authorized user to access network services via the private access network. However, when the authorized user is at other locations that are not proximate to the coverage region of the WAN, the hosting wireless router may cease advertising of the private access network.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

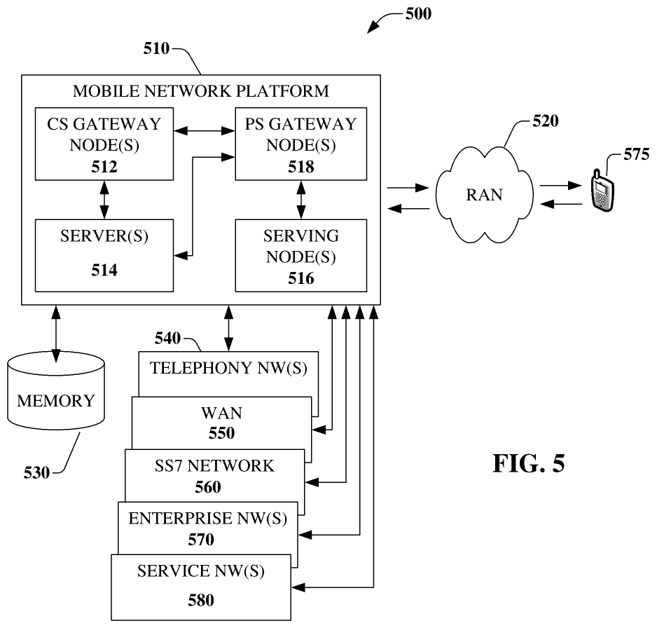

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part control over an availability of a private access network. For example, a private access network, such as a wireless area network (WAN), e.g., a Wi-Fi network, may be configured to be available, or otherwise activated, based on a satisfaction of one or more rules related to a location of an authorized user. To the extent the rule(s) are not satisfied, the private access network can be controlled to an unavailable, or otherwise deactivated condition. For example, if the authorized user is at a location proximate to a coverage region of the WAN, a hosting wireless router can advertise the private access network, e.g., allowing the authorized user and/or any other authorized user to access network services via the private access network. However, when the authorized user is at other locations that are not proximate to the coverage region of the WAN, the hosting wireless router may cease advertising of the private access network. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

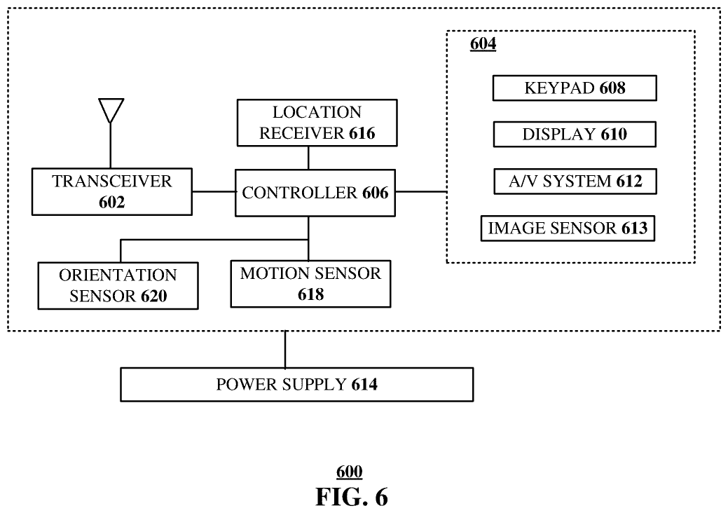

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part control over an availability of a private access network. For example, a private access network, such as a wireless area network (WAN), e.g., a Wi-Fi network, may be configured to be available, or otherwise activated, based on a satisfaction of one or more rules related to a location of an authorized user. To the extent the rule(s) are not satisfied, the private access network can be controlled to an unavailable, or otherwise deactivated condition. For example, if the authorized user is at a location proximate to a coverage region of the WAN, a hosting wireless router can advertise the private access network, e.g., allowing the authorized user and/or any other authorized user to access network services via the private access network. However, when the authorized user is at other locations that are not proximate to the coverage region of the WAN, the hosting wireless router may cease advertising of the private access network.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A method, comprising:
determining, by a processing system including a processor, a first physical location serviceable by a wireless access network;
determining, by the processing system, an indication of a second physical location of a member of a first user group;
comparing, by the processing system, the first physical location to the second physical location to obtain a first comparison result; and
controlling, by the processing system and according to the first comparison result, activation of the wireless access network between an active state in which the wireless access network is available for network service at the first physical location and an inactive state in which the wireless access network is unavailable for service at the first physical location.

2. The method of claim 1, wherein the controlling the activation of the wireless access network further comprises:
activating, by the processing system, the wireless access network to the active state responsive to the first comparison result indicating a proximity of the first and second physical locations.

3. The method of claim 2, wherein the first physical location comprises a first geographic region and wherein the proximity of the first and second physical locations corresponds to an overlapping of the second physical location and the first geographic region.

4. The method of claim 3, wherein the first geographic region corresponds to a wireless coverage region of the wireless access network.

5. The method of claim 2, wherein the activating the wireless access network further comprises:
advertising, by the processing system, an identity of the wireless access network.

6. The method of claim 5, wherein the identity of the wireless access network comprises a service set identifier (SSID).

7. The method of claim 1, wherein the controlling the activation further comprises:
deactivating, by the processing system, the wireless access network responsive to the first comparison result indicating a disparity between the first and second physical locations.

8. The method of claim 7, further comprising:
determining, by the processing system, a time interval, wherein the deactivating the wireless access network occurs after an expiration of the time interval.

9. The method of claim 1, further comprising:
identifying, by the processing system, a scheduled event regarding the member of a first user group, wherein the indication of the second physical location of the member of the first user group is based on the scheduled event.

10. The method of claim 1, further comprising:
determining, by the processing system, an indication of a third physical location of a member of a second user group;
comparing, by the processing system, the first physical location to the third physical location to obtain a second comparison result; and
responsive to the second comparison result indicating a proximity of the first and third physical locations:
deactivating, by the processing system, the wireless access network from an active state to the inactive state; and
preventing, by the processing system, activation of the wireless access network from an inactive state to the active state.

11. The method of claim 1, further comprising:
obtaining, by the processing system, an approximate geographical location of a user device associated with the member of the first user group, wherein the second physical location is based on the approximate geographical location of the user device.

12. A system, comprising:
a processing system including a processor; and
a memory that stores executable instructions that, when executed by the processing system, facilitate performance of operations, the operations comprising:
identifying a first location serviceable by a private access network;
identifying a second location of a user;
comparing the first location to the second location to obtain a comparison result; and
controlling, according to the comparison result, activation of the private access network between an active state in which the private access network is available for network service at the first location and an inactive state in which the private access network is unavailable for service at the first location.

13. The system of claim 12, wherein the controlling the activation of the private access network further comprises:
activating the private access network to the active state responsive to the comparison result indicating a proximity of the first and second locations.

14. The system of claim 13, wherein the activating the private access network further comprises:
advertising an identity of the private access network.

15. The system of claim 14, wherein the private access network comprises a wireless access network, and wherein the identity of the private access network comprises a service set identifier (SSID).

16. The system of claim 12, wherein the controlling the activation further comprises:
deactivating the private access network responsive to the comparison result indicating a disparity between the first and second locations.

17. The system of claim 12, the operations further comprising:
identifying a scheduled event; and
determining a scheduled location of the scheduled event, wherein the second location of the user is based on the scheduled location.

18. A non-transitory, machine-readable medium, comprising executable instructions that, when executed by a processing system including a processor, facilitate performance of operations, the operations comprising:
determining a first location serviceable by a private access network;
determining an indication of a second location of a user;
comparing the first location to the second location to obtain a comparison result; and
controlling, according to the comparison result, activation of the private access network between an active state in which the private access network is available for network service at the first location and an inactive state in which the private access network is unavailable for service at the first location.

19. The non-transitory, machine-readable medium of claim 18, wherein the controlling the activation of the private access network further comprises:
determining a proximity of the first and second locations according to the comparison result; and
activating the private access network to the active state responsive to the proximity of the first and second locations.

20. The non-transitory, machine-readable medium of claim 18, wherein the controlling the activation further comprises:
determining a disparity between the first and second locations according to the comparison result; and
deactivating the private access network responsive to the disparity between the first and second locations.
